(19) United States
(12) Patent Application Publication
(10) Pub. No.: US 2025/0265727 A1
(43) Pub. Date: Aug. 21, 2025

(54) METHOD AND EXTENDED REALITY APPARATUS FOR POSE ESTIMATION

(71) Applicant: Samsung Electronics Co., Ltd., Suwon-si (KR)

(72) Inventors: Rajas Jayant JOSHI, Bangalore (IN); Sarthak SENGUPTA, Bangalore (IN); Rajat Kumar JAIN, Bangalore (IN); Sujoy SAHA, Bangalore (IN); Tarun Vijayanand BAGEWADI, Bangalore (IN)

(21) Appl. No.: 19/051,897

(22) Filed: Feb. 12, 2025

Related U.S. Application Data
(63) Continuation of application No. PCT/KR2025/099326, filed on Feb. 6, 2025.

(30) Foreign Application Priority Data
Feb. 20, 2024 (IN) 202441011607

(51) Int. Cl. G06T 7/73; G06T 19/00

(52) U.S. Cl. CPC G06T 7/73; G06T 19/006

(57) ABSTRACT

A method for estimating a pose of an extended reality (XR) apparatus is provided. The method includes receiving, by the XR apparatus, at least one first frame received from at least one camera, determining, by the XR apparatus, a first set of key points in the at least one first frame, receiving, by the XR apparatus, at least one second frame received from the at least one camera, tracking, by the XR apparatus, movements of each key point of the first set of key points of the at least one first frame in the at least one second frame, determining, by the XR apparatus, a second set of key points in the at least one second frame based on the tracked movements of each key point of the first set of key points in the at least one second frame, tracking, by the XR apparatus, movements of each key point of the second set of key points of the at least one second frame, and determining, by the XR apparatus, the pose of the XR apparatus based on the tracked movements of each key point of the second set of key points of the at least one second frame.

### CROSS-REFERENCE TO RELATED APPLICATION(S)

This application is a continuation application, claiming priority under § 365(c), of an International application No. PCT/KR2025/099326, filed on Feb. 6, 2025, which is based on and claims the benefit of an Indian patent application number 202441011607, filed on Feb. 20, 2024, in the Indian Intellectual Property Office, the disclosure of which is incorporated by reference herein in its entirety.

### FIELD OF INVENTION

The disclosure relates to smart electronic devices and extended reality environment. More particularly, the disclosure relates to a method and extended reality (XR) apparatus for determining pose estimation.

### BACKGROUND OF THE INVENTION

The advent of cutting-edge artificial intelligence (AI) techniques has paved the way for the introduction of a multitude of new devices. To ensure seamless execution and prevent any discomfort or harm to the user, it is crucial to bolster the various techniques running on these devices of the related art. More particularly, use cases involving augmented reality navigation and human-device interaction necessitate the localization and orientation of the device in 3-dimensional (3D) space, as well as the generation of an environment map for reference. According to the related art, this information was obtained through the simultaneously localization and mapping (SLAM) method. To track and generate a map, specialized recognizable key points in each frame are utilized to determine the device pose. However, the success of the SLAM pipeline hinges on the detection and matching of these key points, which require specific properties to perform optimally. Incorporating these properties into training models comes at the cost of precious running time during inference.

The key point detection and matching techniques traditionally employed in SLAM have been adapted from image processing techniques and lack specialization for this specific context. These techniques operate on the entire image, often producing imprecise results that must be corrected via various means. Although learning-based methods have been developed to enhance repeatability and facilitate accurate pose calculation, their efficacy is limited to a certain degree. Furthermore, the utilization of deep neural networks renders the module more expensive. In the case of SLAM devices that incorporate multiple high-resolution and wide-angle fish-eye cameras, the cost of key point detection rises significantly. Specializing key point detection for SLAM through targeted training can improve robustness, but comes at a cost.

The above information is presented as background information only to assist with an understanding of the disclosure. No determination has been made, and no assertion is made, as to whether any of the above might be applicable as prior art with regard to the disclosure.

### OBJECTS OF INVENTION

Aspects of the disclosure are to address at least the above-mentioned problems and/or disadvantages and to provide at least the advantages described below. Accordingly, an aspect of the disclosure is to provide a method and XR apparatus determining pose estimation.

Another aspect of the disclosure is to utilize the observation that certain regions of the frame become invisible in successive frames due to motion, making the key points in those areas redundant for tracking and pose estimation purposes.

Another aspect of the disclosure is to provide a deep learning (DL)-based key point detector that generates consistent key points, thereby ensuring superior accuracy and increased traceability of the subset of key points within the frame. As a result, utilization of memory resources is more effective.

Another aspect of the disclosure is to detect key points within a specific area of the frame by leveraging the apparatus estimated motion. The information is then fed through a pre-trained artificial intelligence model to ascertain the user's head pose.

Another aspect of the disclosure is to employ a dynamic window based on estimated motion to train a key point detector based on deep learning. This is done to ensure the necessary level of repeatability and to minimize errors in pose.

Another aspect of the disclosure is to provide the XR apparatus that increases efficiency by running only on the part of the frame which is estimated to have the most contribution in tracking in future frames. The part of the frame is determined using estimated motion of the apparatus, based on the inertial measurement unit (IMU) sensor readings.

Additional aspects will be set forth in part in the description which follows and, in part, will be apparent from the description, or may be learned by practice of the presented embodiments.

In accordance with an aspect of the disclosure, a method for estimating a pose of an XR apparatus is provided. The method includes receiving, by the XR apparatus, at least one first frame received from at least one camera, determining, by the XR apparatus, a first set of key points in the at least one first frame, receiving, by the XR apparatus, at least one second frame received from the at least one camera, tracking, by the XR apparatus, movements of each key point of the first set of key points of the at least one first frame in the at least one second frame, determining, by the XR apparatus, a second set of key points in the at least one second frame based on tracked movements of each key point of the first set of key points in the at least one second frame, tracking, by the XR apparatus, movements of each key point of the second set of key points of the at least one second frame, and determining, by the XR apparatus, the pose of the XR apparatus based on the tracked movements of each key point of the second set of key points of the at least one second frame.

In an embodiment of the disclosure, the method includes determining the second set of key points in the at least one second frame based on the tracked movements of each key point. A first set of key points in the at least one second frame comprises determining a number of key points from the first set of key points available in the at least one second frame based on the tracked movements of each key point of the set of each key points of the at least one first frame in the at least one second frame. The method also includes determining whether the number of key points meets a key point threshold. The key point threshold indicates an overlap region between the at least one first frame and the at least one second frame. The method also includes determining at least one second frame as key frame when the number of key points meets the key point threshold. The method also includes tracking movements of each key point of the first set of key points of the at least one first frame in the at least one second frame comprises receiving motion data of each key point of the first set of key points of the at least one first frame in the at least one second frame from at least one IMU sensor. Further, the method tracks movements of each key point of the first set of key points of the at least one first frame in the at least one second frame based on the motion data of each key point of the first set of key points of the at least one first frame in the at least one second frame.

In an embodiment of the disclosure, the method of determining a first set a first set of key points in the at least one frame includes detecting plurality of key points in in at least one frame using a key point detection technique. Further, the method includes determine the first set of key points by selecting from the plurality of key points based on at least one of a confidence score of key point, location of key point and relative location of key point.

In an embodiment of the disclosure, the method includes tracking the movements of each key point of the second set of key points of the at least one second frame comprises receiving motion data of each key point of the second set of key points of the at least one second frame from at least one IMU sensor. The method also includes tracking the movements each key point of the second set of key points of the at least one second frame based on the motion data of each key point of the second set of key points of the at least one second frame. The method also includes receiving at least one second frame received from the at least one camera comprises estimating plurality of second frames of the at least one first frame based on an estimated motion of the at least one camera. The method selects at least one second frame from a plurality of second frames having minimum overlapping region with at least first frame, wherein the minimum overlapping region comprises the second set of key points greater than a predefined threshold key points. The method also includes determining the second set of key points in the at least one second frame comprises dividing the at least one second frame into a plurality of segments. Thereafter, the method determines coordinates of minimum overlap region between at least one first frame and at least one second frame by remapping a coordinate of the plurality of segments with the image coordinates of at least one second frame. The method also includes determining the second set of key points on the minimum overlapping region.

In an embodiment of the disclosure, the method also includes determining the minimum overlap region between the at least one first frame and the at least second frame comprises determining a location of the at least one second frame in estimated motion direction of the camera based on number of frames generated per second. The method also includes transforming view of the at least one second frame in the frame location by rotating and translating in the estimated motion of the camera. The method also includes determining minimum overlapping region between the transformed at least one second frame and the at least one first frame.

In accordance with another aspect of the disclosure, an XR apparatus for estimating a pose of a user is provided. The XR apparatus includes memory storing one or more computer programs, one or more processors and a pose estimation controller, communicatively coupled to the memory and the one or more processors, wherein the one or more computer programs include computer-executable instructions that, when executed by the one or more processors individually or collectively, cause the XR apparatus to receive at least one first frame received from a at least one camera, determine a first set of key points in the at least one first frame, and receive at least one second frame received from the at least one camera, track movements of each key point of the first set of key points of the at least one first frame in the at least one second frame, and determine the pose of the XR apparatus based on the tracked movements of each key point of a second set of key points of the at least one second frame.

In accordance with an aspect of the disclosure, one or more non-transitory computer-readable storage media storing computer-executable instructions that, when executed by one or more processors individually or collectively, cause an extended reality (XR) apparatus to perform operations of estimating a pose of a user are provided. The operations include receiving, by the XR apparatus, at least one first frame received from a at least one camera, determining, by the XR apparatus, a first set of key points in the at least one first frame, receiving, by the XR apparatus, at least one second frame received from the at least one camera, tracking, by the XR apparatus, movements of each key point of the first set of key points of the at least one first frame in the at least one second frame, determining, by the XR apparatus, a second set of key points in the at least one second frame based on the tracked movements of each key point of the first set of key points in the at least one second frame, tracking, by the XR apparatus, movements of each key point of the second set of key points of the at least one second frame, and determining, by the XR apparatus, the pose of the XR apparatus based on the tracked movements of each key point of the second set of key points of the at least one second frame.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 depicts a detection and matching of key points across two frames according to the related art;

FIG. 2A illustrates detection of key points on a keyframe, as well as a subsequent tracking of said key points across multiple frames, according to the related art;

FIG. 2B illustrates a geometrical perspective of a relative positions of multiple frames according to the related art;

FIG. 3A illustrates tracking of significant points across successive frames, which is accomplished by leveraging camera motion, according to the related art;

FIG. 3B illustrates prediction of subset of key points with higher confidence by a DL based model, according to the related art;

FIG. 4A depicts a detection of a key point in a frame through a utilization of a features from accelerated and segments test (FAST) technique, according to the related art;

FIG. 4B depicts a detection of a key point within a frame through a use of an oriented fast and brief (ORB) technique, according to the related art;

FIG. 5 is a block diagram that illustrates detecting specialized key points for SLAM according to an embodiment of the disclosure;

FIG. 6 depicts an overlap region between a present keyframe and an estimated keyframe according to an embodiment of the disclosure;

FIG. 7A depicts an estimate of a frame based on motion that exhibits an overlap greater than a threshold with an original keyframe according to an embodiment of the disclosure;

FIG. 7B illustrates an overlap region between a current keyframe and an estimated keyframe according to an embodiment of the disclosure;

FIG. 8 illustrates a scenario in which a detected key points are tracked on an overlapping region that has been determined according to an embodiment of the disclosure;

FIG. 9A depicts a sub-region within keyframe that has been partitioned into diminutive grid cells according to an embodiment of the disclosure;

FIG. 9B depicts a predicted final frame within dynamic window according to an embodiment of the disclosure;

FIG. 10 is a block diagram that illustrates training of a neural network using estimated number of frames according to an embodiment of the disclosure;

FIG. 11 illustrates a calculation of pose error loss between key frames and subsequent frame according to an embodiment of the disclosure;

FIG. 12 illustrates a calculation of repeatability loss between key frame and subsequent frame according to an embodiment of the disclosure;

FIG. 13 is a block diagram that illustrates a system for pose estimation by an XR apparatus according to an embodiment of the disclosure; and

FIG. 14 is a flowchart that illustrates a method for pose estimation by an XR apparatus according to an embodiment of the disclosure.

FIGS. 15A and 15B are diagrams illustrating a wearable device according to various embodiments of the disclosure.

The same reference numerals are used to represent the same elements throughout the drawings.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The existing techniques face a number of challenges. Key-point detection and matching techniques, which are commonly used in SLAM, have evolved from image processing and are not specialized for the SLAM context. These techniques are applied to the entire image and often produce inaccurate outputs, which then have to be corrected using various methods. While recent learning-based methods attempt to address these issues by ensuring repeatability in key-points and accurate pose calculation, they are only able to do so to a limited extent. Furthermore, the use of a Deep Neural Network makes the module even more resource-intensive.

The introduction of new devices containing multiple higher resolution and higher field of view (FOV) fish-eye cameras for SLAM has further increased the cost of key-point detection. While training for key-point specialization increases robustness, it also results in longer running times.

To overcome these challenges, a fast learning-based key-point detector has been proposed that outputs key-points on only a portion of the frame as described herein. This portion is dynamically determined based on the current motion of the device, leveraging the fact that some areas of the frame go out of view in subsequent frames and the key-points in those regions are no longer useful for tracking and pose estimation. By using an accurate DL-based key-point detector that outputs repeatable key-points, the proposed solution ensures good accuracy and higher trackability of the subset of key-points in the frame, leading to a more efficient use of memory.

The proposed solution includes determining the dynamic window size based on the current motion of the device, which specifies the area in the frame that requires key-point detection. The same dynamic window size determination is also used during training to ensure repeatability of the key-points and good pose accuracy for at least the specified window size.

Accordingly, embodiments disclosed herein provide a method and XR apparatus for estimating a pose of a user. The method includes receiving at least one first frame received from a at least one camera. The method includes determining a first set of key points in the at least one first frame and receiving at least one second frame received from the at least one camera. Further, the method includes tracking movements of each key point of the first set of key points of the at least one first frame in the at least one second frame. Thereafter, the method includes determining a second set of key points in the at least one second frame based on the tracked movements of each key point of the first set of key points in the at least one second frame. The method includes tracking movements of each key point of the second set of key points of the at least one second frame and determining the pose of the XR apparatus based on the tracked movements of each key point of the second set of key points of the at least one second frame.

In an embodiment of the disclosure, the method includes determining the second set of key points in the at least one second frame based on the tracked movements of each key point of the first set of key points in the at least one second frame comprises determining a number of key points from the first set of key points available in the at least one second frame based on the tracked movements of each key point of the set of each key points of the at least one first frame in the at least one second frame. Further, the method includes determining whether the number of key points meets a key point threshold. The key point threshold indicates an overlap region between at least one first frame and the at least one second frame. The method also includes determining at least one second frame as key frame when the number of key points meets the key point threshold. Further, the method also includes tracking movements of each key point of the first set of key points of the at least one first frame in the at least one second frame comprises receiving motion data of each key point of the first set of key points of the at least one first frame in the at least one second frame from at least one IMU sensor. The method includes tracking movements of each key point of the first set of key points of the at least one first frame in the at least one second frame based on the motion data of each key point of the first set of key points of the at least one first frame in the at least one second frame.

In an embodiment of the disclosure, the method includes tracking movements of each key point of the second set of key points of the at least one second frame comprises receiving motion data of each key point of the second set of key points of the at least one second frame from at least one IMU sensor. The method includes tracking movements each key point of the second set of key points of the at least one second frame based on the motion data of each key point of the second set of key points of the at least one second frame. The method also includes receiving at least one second frame received from the at least one camera comprises estimating plurality of second frames of the at least one first frame based on an estimated motion of the at least one camera. Thereafter, the method includes selecting at least one second frame from a plurality of second frames having minimum overlapping region with at least first frame. The minimum overlapping region comprises the second set of key points greater than a predefined threshold key points. Further, the method includes determining the second set of key points in the at least one second frame comprises at least one second frame into a plurality of segments. The method also includes determining coordinates of minimum overlap region between at least one first frame and at least one second frame by remapping a coordinate of the plurality of segments with the image coordinates of at least one second frame. The method also includes determining the second set of key points on the minimum overlapping region.

In an embodiment of the disclosure, the method includes determining the minimum overlap region between the at least one first frame and the at least second frame comprises determining a location of the at least one second frame in estimated motion direction of the camera based on number of frames generated per second. The method includes transforming view of the at least one second frame in the frame location by rotating and translating in the estimated motion of the camera. The method includes determining minimum overlapping region between the transformed at least one second frame and the at least one first frame.

In an embodiment of the disclosure, an XR apparatus for estimating a pose of a user comprises memory, a processor and a pose estimation controller, communicatively coupled to the memory and the processor. The XR apparatus configured to receive at least one first frame received from at least one camera. The XR apparatus determines a first set of key points in the at least one first frame. The XR apparatus receives at least one second frame received from the at least one camera. The XR apparatus tracks movements of each key point of the first set of key points of the at least one first frame in the at least one second frame and also determines the pose based on the tracked movements of each key point of the second set of key points of the at least one second frame.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

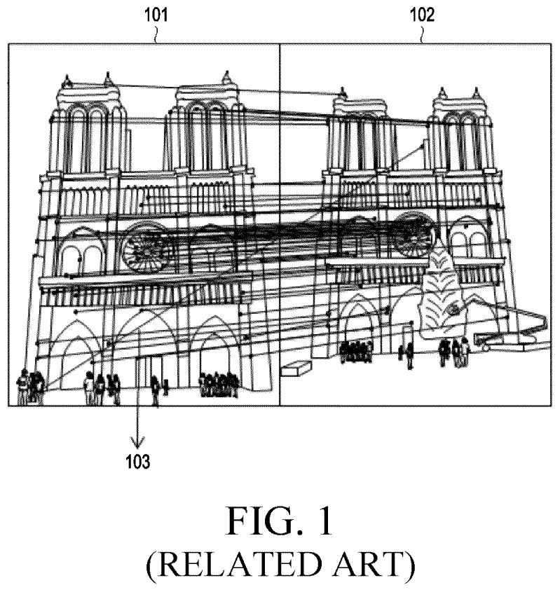

Referring now to the drawings, and more particularly to FIG. 1 through 14 where similar reference characters denote corresponding features consistently throughout the figures, there are shown preferred embodiments.

FIG. 1 depicts a detection and matching of key points across two frames according to the related art.

Referring to FIG. 1, a frame is a single image in a video, or a sequence of images. In simultaneous localization and mapping (SLAM), key point detection is exclusively performed on keyframes. Additionally, the detected key points are tracked between keyframes to the greatest extent possible. For instance, keyframe 101 is initially utilized for key point detection, and a subsequent frame 102 of the keyframe 101 is captured by a camera 1301. In the subsequent frame 102, the key points are tracked with respect to the keyframe 101 using a tracking method, such as Lucas-Kanade optical flow tracking. Following the tracking of key points between the keyframe 101 and the subsequent frame 102, it is observed that the number of key points tracked in the subsequent frame 102 decreases because the key points in keyframe 101 are going out of view due to the motion of the camera 1301.

In an embodiment of the disclosure, the keyframe 101 is tracked with one or more subsequent frames 102. Moreover, it is detected whether the number of key points tracked in each of the subsequent frames falls below a predefined threshold value. Upon successful detection, the subsequent frame 102 is considered as the keyframe, and key point detection is repeated. Hence, in the existing technique, keyframes are also used to track landmarks in a map generated in SLAM. A higher number of keyframes leads to a bulkier map, which consumes more memory. Landmarks refer to the localization or detection of key points, while the bulkier map refers to the large area where key point detection is necessary.

Once key point detection is performed, the matched key points are represented by a connecting line 103 between the first keyframe 101 and the subsequent frame 102. These matched key points are used to determine the relative pose between the two frames. The method of the related art consumes more computation time.

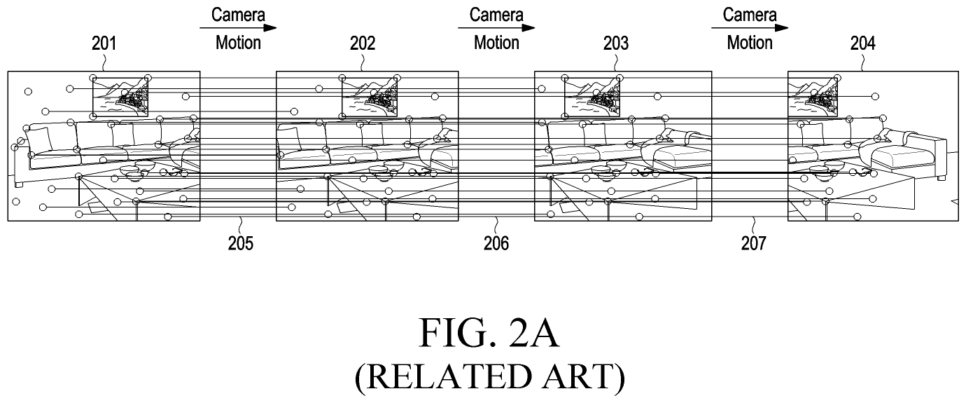

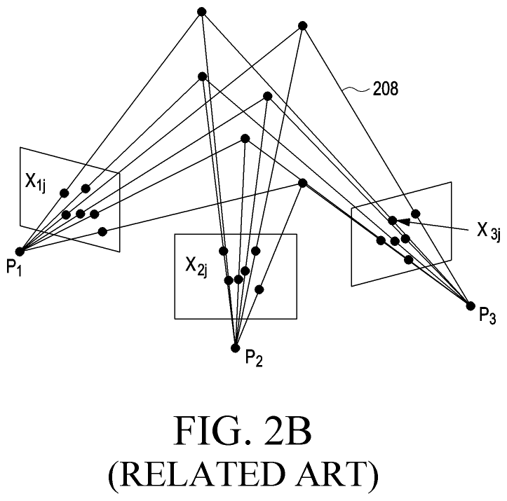

FIG. 2A illustrates detection of key points on a keyframe, as well as a subsequent tracking of said key points across multiple frames, according to the related art.

Referring to FIG. 2A, where a camera 1301 is moving in the rightward direction and generating subsequent frames based on its motion. Initially, a keyframe 201 is captured by the camera 1301, and a multitude of key points are detected 205 within it using a key point detection technique, such as FAST or ORB. As subsequent frames 202, 203, 204 are captured, key point detection is performed on both the keyframe 201 and the subsequent frames 202, 203, 204. The key points in the keyframe 201 and subsequent keyframes 202, 203, 204 are detected and tracked 206 in each subsequent frame, with the key points in the subsequent frame 202 being mapped 207 to the next immediate subsequent frame 203. This process of tracking continues until the number of key points in the subsequent frames 202, 203, 204 falls below a predefined threshold value. At this point, the subsequent frame is converted to the new keyframe, and the key point detection process runs again. It is worth noting that the method of the related art consumes a significant amount of computation time, leading to inefficiencies in the process.

FIG. 2B illustrates a geometrical perspective of a relative positions of the multiple frames according to the related art.

Referring to FIG. 2B, the approach of the related art of key point matching often yields spurious match results and subpar accuracy in determined poses. In contrast, a deep learning-based approach incorporates pose estimation error as a loss function, ensuring that detected and matched key points are precise and selected to contribute most to an accurate pose. Following the matching of key points in multiple frames (X1j X2j X3j), the relative poses of views by points P1, P2, and P3 are determined using geometry 208, as depicted in FIG. 2B. Subsequently, the emphasis is placed on repeatability and key point selection, resulting in higher pose accuracy. While this property may not be necessary for other tasks, it is particularly advantageous in the context of SLAM. Key point detectors of the related art fail to deliver higher pose accuracy, whereas even if deep learning can detect superior key points for SLAM, the method of the related art may be too slow to be integrated into the SLAM pipeline.

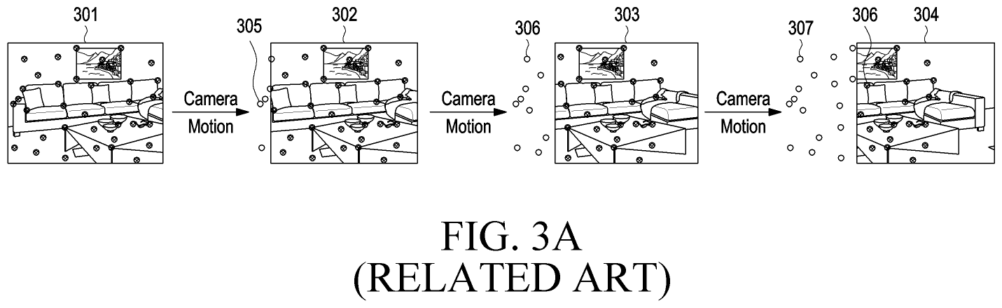

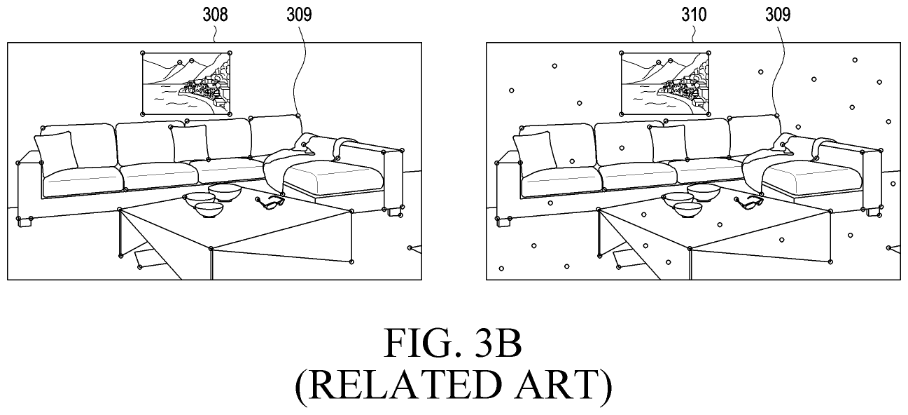

FIG. 3A illustrates tracking of significant points across successive frames, which is accomplished by leveraging camera 1301 motion, according to the related art.

Referring to FIG. 3A, consider the camera 1301 depicted in FIG. 3A moving towards the right. Initially, the camera 1301 captures a keyframe 301 and detects key points within it. Subsequently, as the camera 1301 moves, it captures subsequent frames 302, 303, 304. The key points detected in the keyframe 301 are then tracked with respect to the subsequent frames 302, 303, 304. The tracking (which is based on the motion) is how the keypoints are detected in subsequent frames. Detection happens only in the keyframes, the points are then tracked in subsequent frames. Thus, detection happens only in the keyframes, the points are then tracked in subsequent frames. However, during this process, it is observed that certain key points 305 disappear from the view of the SLAM camera 1301 in subsequent frames 302 in relation to the keyframe 301. Similarly, other key points 306 disappear from the view of the camera 1301 in subsequent frames 303 in relation to the keyframe 301, and yet others 307 disappear in subsequent frames 304. These disappearing key points are not necessary for pose estimation and their detection in the whole region of each subsequent frame 302, 303, 304 results in intensive computations. Furthermore, detecting key points that cross the field of view but are no longer useful for tracking leads to unnecessary resource wastage.

FIG. 3B illustrates prediction of subset of key points with higher confidence by a DL based model according to the related art.

Referring to FIG. 3B, techniques of the related art involve manual crafting and rely on identifying corner key points 309 based on the contrast of neighboring pixels in a frame 308. In contrast, deep learning-based methods circumvent this requirement by detecting key points 309 that are inherent features in the frame 310, resulting in highly precise pose estimation. In real-world scenarios, particularly in indoor environments, numerous surfaces may lack sufficient texture and therefore, corners may not be readily discernible. However, deep learning-based methods are trained to minimize pose estimation loss and identify features that ensure superior accuracy, regardless of whether corners possess a specific contrast score.

While traditional methods train key points to yield high accuracy with even a subset of detected and matched key points, as few as eight accurately matched key points can theoretically determine the pose between two overlapping frames. Additional key points are necessary for redundancy and error reduction. Unlike other methods, deep learning-based methods predict a subset of key points with higher confidence. However, the deep learning-based method fails to provide accurate result in less time.

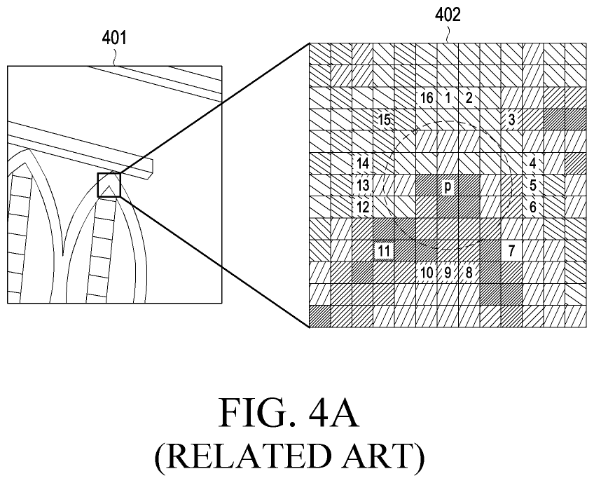

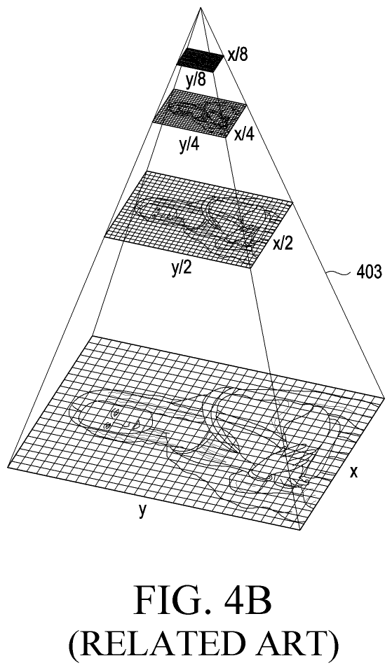

FIG. 4A depicts a detection of a key point in a frame through a utilization of a features from accelerated and segments test (FAST) technique according to the related art.

Referring to FIG. 4A, SLAM methods typically utilize traditional key points identified through the FAST technique. The detection of key points is a crucial aspect of the widely-used sparse SLAM technique. The FAST technique involves comparing the brightness of a given pixel to the surrounding 16 pixels in a frame 402. If more than 8 pixels in the frame 401 are either darker or brighter than the current pixel, they are selected as key points. While these key points have proven effective in determining the pose between frames, the FAST technique does not specialize in or guarantee key points that are repeatable in subsequent frames. Therefore, higher-confidence key points are more likely to result in accurate calculations of the relative pose. However, the key point detection process in the FAST technique is performed on the entire frame, which consumes more computational resources and may lead to inaccuracies in the results.

FIG. 4B depicts a detection of a key point within a frame through a use of an ORB technique according to the related art.

Referring to FIG. 4B, it depicts an image that is traditionally processed using ORB's fast multiscale image pyramid 403, which renders the image partially scale invariant. Additionally, ORB incorporates orientation information by analyzing the distribution of surrounding intensities. While key points have proven effective in determining the pose between frames, ORB does not specialize in or guarantee key points that are likely to be found in subsequent frames (repeatability). Therefore, higher-confidence key points are more suitable for achieving accurate relative pose calculations. However, the key point detection process in ORB is performed on the entire frame, resulting in increased computational load and reduced accuracy in the results.

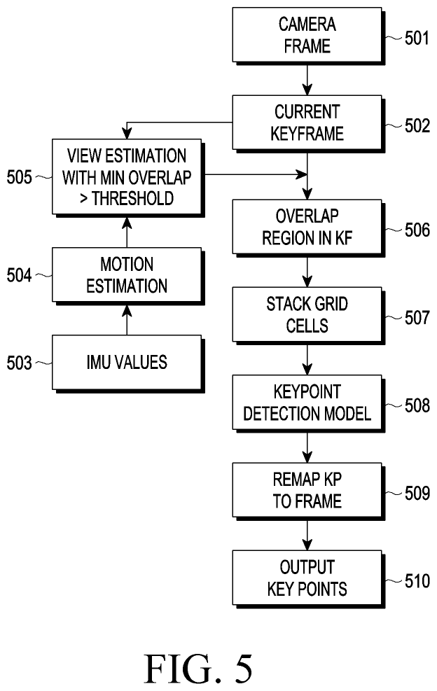

FIG. 5 is a block diagram that illustrates detecting specialized key points for SLAM according to an embodiment of the disclosure.

Referring to FIG. 5, an XR apparatus 1300 captures a plurality of camera 1301 frames 501 through one or more cameras 1301, from which the current keyframe 502 is selected. A frame refers to a single image in a video or sequence of images, while the keyframe is used for detecting fresh key points. Simultaneously, the captured frame's IMU values 503 are received from one or more motion sensors. The motion prediction model then estimates the motion 504 of the captured frame, using IMU values, such as angular velocity and acceleration.

The motion prediction model predicts an estimated keyframe that has a minimal overlap region 506 with the current keyframe, where the key points in the overlapping region are greater than or equal to a predefined threshold value 505. The overlap region 506 of the estimated keyframe and current keyframe is divided into small grid cells, and a key point detection model 508 detects key points in these cells 507.

Thereafter, the key points 509 are remapped to the keyframe, providing output key points 510 that are more confident and accurate.

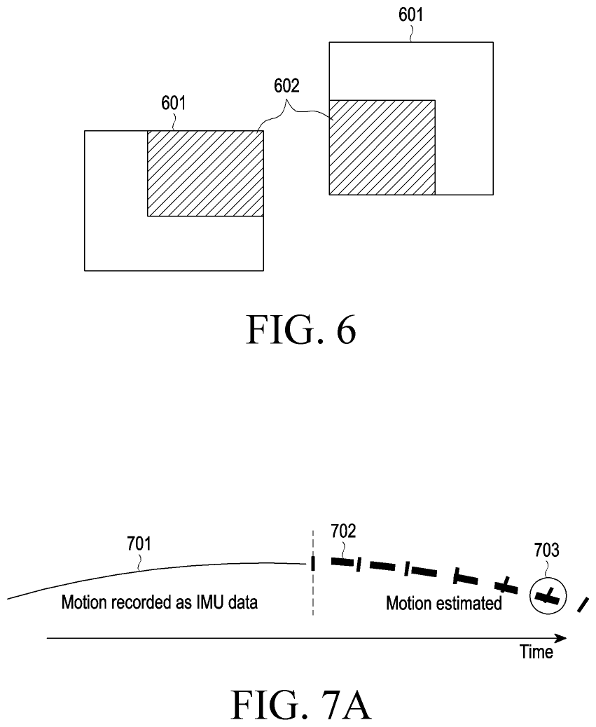

FIG. 6 depicts an overlap region between a present keyframe and an estimated keyframe according to an embodiment of the disclosure.

Referring to FIG. 6, a pictorial representation of the overlapping area between a current keyframe 601 and an estimated frame 603 is illustrated. The estimated frame 603 is one that has a minimum overlap region that exceeds a predetermined threshold value. Additionally, the motion prediction model predicts the estimated frame with reference to the current keyframe 601, based on the motion estimation of the latter, which is determined by the IMU values 503 obtained from one or more motion sensors. Furthermore, the motion prediction model predicts the estimated frame by considering the overlap region 602 in relation to the current keyframe 601. More particularly, for the estimated frame 603, the overlap region 602 must have key points that exceed a predefined threshold value.

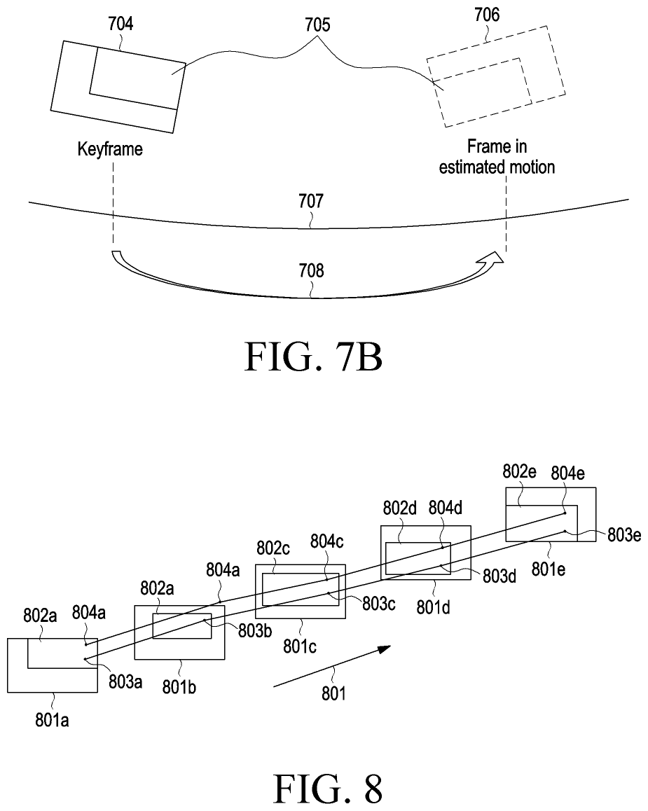

FIG. 7A depicts an estimate of a frame based on motion that exhibits an overlap greater than a threshold with an original keyframe according to an embodiment of the disclosure.

Referring to FIG. 7A, let us consider the scenario where a camera 1301 frame is captured by one or more cameras 1301 of the XR apparatus 1300, subsequently producing the current keyframe 702. The IMU sensors, which are also associated with the XR apparatus 1300, are used to obtain the IMU values for the current frame. The IMU sensor is a device that measures and reports the specific gravity and angular rate of an object to which it is attached. The IMU sensor includes gyroscopes and accelerometers. Based on the IMU data, the motion of the current keyframe 702 is recorded, along with the trajectory 701 of the XR apparatus 1300 with respect to the device. Further, a motion prediction model is used to predict an estimated frame 703.

FIG. 7B illustrates an overlap region between a current keyframe and an estimated keyframe according to an embodiment of the disclosure.

Referring to FIG. 7B, an overlap region is depicted between the current keyframe and the estimated keyframe, as per the disclosed embodiments. One or more cameras 1301 of the XR apparatus 1300 capture the current keyframe 704, while a prediction model generates an estimated keyframe 706. The overlapping region of the current frame and estimated frame is determined. Further, the determined overlapping region 705 between the two frames has a value greater than the threshold. The camera 1301 motion is used to estimate the motion of the current keyframe, and with the estimated motion and known frame per second (fps) of frame generation, the frame locations in the estimated motion are determined. By transforming the keyframe view through rotation and translation (R & T) 708 in the estimated motion, the view and overlap with the keyframe are determined for the frame locations. A binary search is then conducted to efficiently find the frame with an overlap greater than the threshold with the current keyframe. This approach enables key point detection to be performed only in the overlapping region 705, thereby enhancing detection speed by dynamically adapting to the device's motion. Additionally, performing key point detection only in the overlap region enhances accurate pose estimation and reduces memory consumption.

FIG. 8 illustrates a scenario in which a detected key points are tracked on an overlapping region that has been determined according to an embodiment of the disclosure.

Referring to FIG. 8, upon detecting the key points in the overlapping region of the current frame with the estimated frame, the method for pose estimation by an XR apparatus 1300 commences tracking the identified key points in the overlapping region of subsequent frames. The subsequent frames, namely 801a, 801b, 801c, 801d, and 801e, have overlapping regions denoted by 802a, 802b, 802c, 802d, and 802e respectively. The detected key points in the overlapping region of the first subsequent frame 801a are 803a and 804a, while those in the second subsequent frame 801b are 803b and 804b. Similarly, the third subsequent frame 801c has detected key points 803c and 804c, while the fourth subsequent frame 801d has 803d and 804d. The fifth subsequent frame 801e has detected key points 803e and 804e.

Furthermore, the overlapping region between the first keyframe and the last frame in the determined window also appears in the intermediate frames. The key points detected in the overlapping region of the keyframe are tracked up to the final frame of the window, resulting in reduced memory consumption by limiting the determination of key points solely in the estimated overlapping region of the current keyframe. This process is illustrated in FIG. 8.

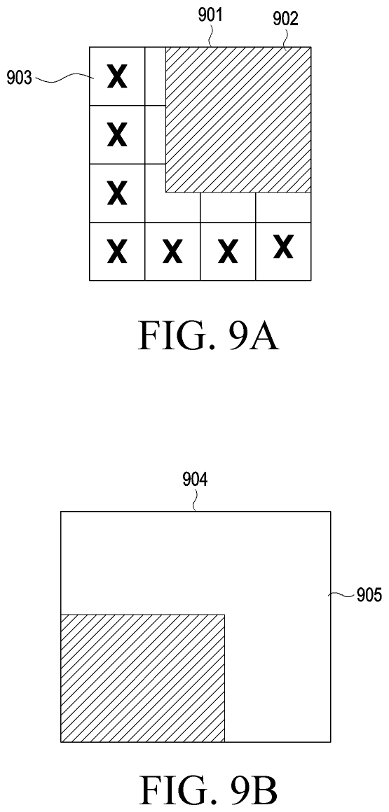

FIG. 9A depicts a sub-region within keyframe that has been partitioned into diminutive grid cells according to an embodiment of the disclosure.

Referring to FIG. 9A, an estimated keyframe 901 and its overlapping region 902 with the current keyframe are identified, possessing a value exceeding the threshold value. Subsequently, the estimated keyframe is partitioned into smaller grid cells 903. Key point detection is restricted to the small grid cells 903 that encompass the determined overlapping region 902.

FIG. 9B depicts a predicted final frame within dynamic window according to an embodiment of the disclosure.

Referring to FIG. 9B, the motion prediction model anticipates the estimated keyframe 904, followed by the acquisition of the final frame 905 within the window.

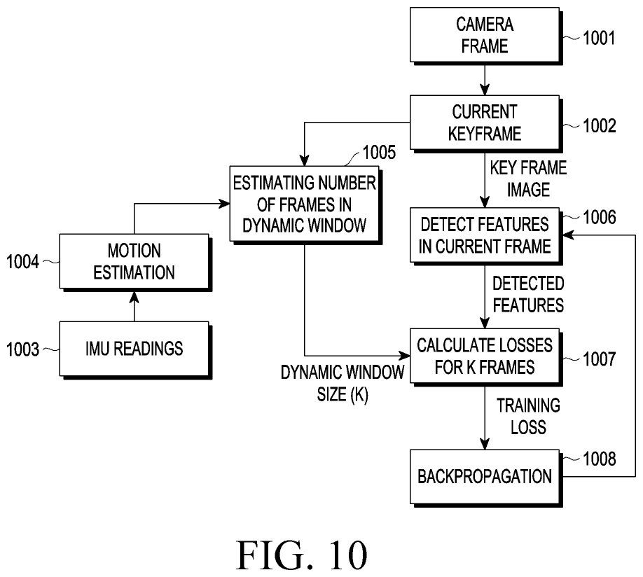

FIG. 10 is a block diagram that illustrates training of a neural network using estimated number of frames according to an embodiment of the disclosure.

Referring to FIG. 10, a camera 1301 frame 1001 is captured by one or more cameras 1301 affiliated with a virtual reality apparatus, resulting in the current keyframe 1002. The IMU readings 1003 of the captured frame are acquired by an IMU sensor. Additionally, motion estimation 1004 of the captured frame is performed by the motion prediction model. The motion prediction model predicts the number of frames in a dynamic window 1005, where k denotes the size of the dynamic window. The dynamic window is a theoretical window where the motion prediction model estimates the number of frames that have a minimum overlap region larger than the threshold value. Once the estimation of the number of frames is completed, the losses is determined for k frames 1007. The motion prediction model detects the features in the current keyframe 1006. Subsequently, the determined losses are backpropagated to train the feature detection model. Further, the features of the current keyframe 1006 are detected.

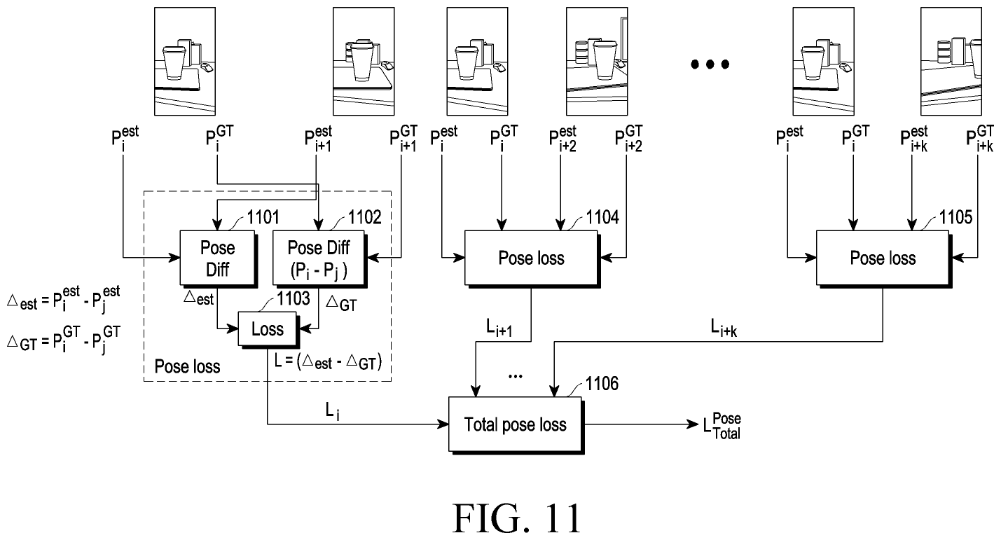

FIG. 11 illustrates a calculation of pose error loss between key frames and subsequent frame according to an embodiment of the disclosure.

Referring to FIG. 11, consider a scenario of a camera 1301 motion in the right direction. Further, subsequent frames are generated based on the camera 1301 motion. Further, while comparing one subsequent frame to another immediate subsequent frame, some potential error loss is generated. Pᵢ^{est} 1101 is the potential error of the first subsequent frame., Pᵢ^{GT} is the ground truth value of the first keyframe. Pᵢ₊₁^{est} 1102 is the poss error of the second frame. Pᵢ₊₁^{GT} is the ground truth value of the second subsequent frame. Further, the pose loss 1103 of the current frame and subsequent frame is determined, denoted by Δest.

where,

$$\begin{matrix}{Δ}_{est} = {P}_{i}^{est} - {P}_{j}^{est} \\ {Δ}_{Gt} = {P}_{i}^{Gt} - {P}_{j}^{Gt}\end{matrix}$$

The pose loss 1103 of the ground truth value of the current frame and immediate subsequent frame is also determined, denoted by G_{Q}. By taking the difference between Rₑₛₜ and A_{gta}, the error loss between two immediate subsequent frames is determined.

where,

$${L}_{i} = {b}_{est} - {G}_{Q}$$

Similarly, the pose error loss [symbol] (L [symbol] ᵢ₊₁)) 1104 is determined for the next two subsequent frame i.e., Pᵢ₊₁^{est} and Pᵢ₊₂^{GT}, where pest Pᵢ₊₁^{est} is the pose error of next subsequent frame and Pᵢ₊₂^{GT} is the ground truth value of the next subsequent frame. Likewise, the pose error loss [symbol] (L [symbol] ᵢ₊ₖ)) 1105 is determined for the k subsequent frame i.e., Pₖ₊₁^{est} and Pₖ₊₂^{GT}, where Pₖ₊₁^{est} is the poss error of next subsequent frame and Pₖ₊₂^{GT} is the ground truth value of the next subsequent frame, k is the number of subsequent frame. The total pose loss P_{Total}^{Pose} 1106 is determined by taking the summation of the determined pose error loss. The equation is as below:

$${L}_{Total}^{Pose} = \frac{1}{k} \times {\sum }_{j = 1}^{k} {wjL}_{j}$$

The pose error loss 1106 is the part of the training loss that minimizes the error in the estimated pose while comparing it with k subsequent frames, depending on the extent of motion.

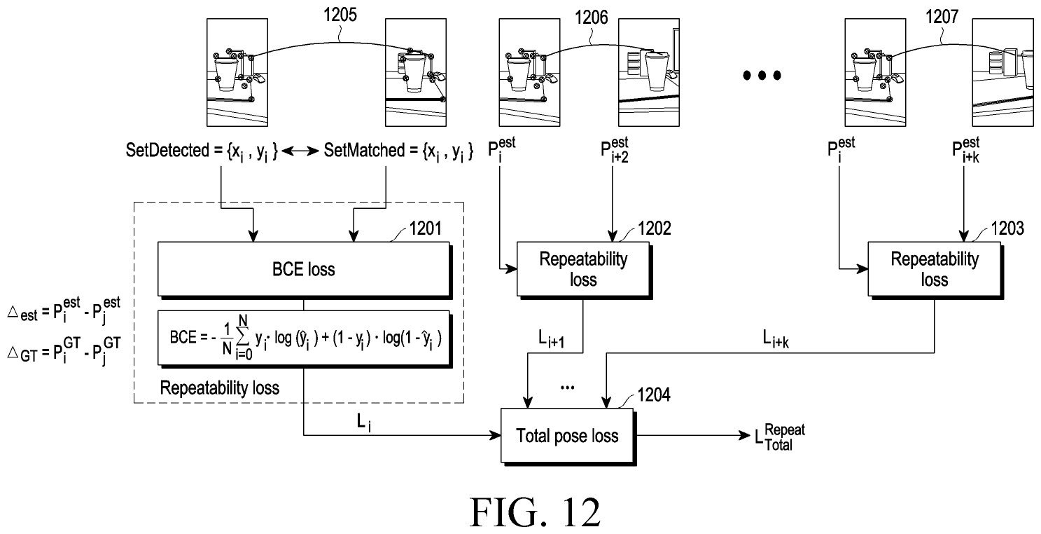

FIG. 12 illustrates a calculation of repeatability loss between key frame and subsequent frame according to an embodiment of the disclosure.

Referring to FIG. 12, consider a scenario of a camera 1301 motion in the right direction. Subsequent frames are generated based on the camera 1301 motion. A set of key points are detected in the frame. Transformation of points 1205 takes place from one frame to the immediate subsequent frame. Similarly, transformation of points 1206 takes place from one frame to another immediate subsequent frame. Likewise, transformation of points 1207 takes place from one frame to another immediately subsequent frame. A set of key points are detected and a set of key points that are matched, represented as {xᵢ, yi}. By taking the parameters of detected set of points and matched set of points, a binary cross entropy (BCE) 1201 loss is determined. The BCE loss 1201 also consists the parameters of Δₑₛₜ and Δ_{Gt}.

where,

$$\begin{matrix}{Δ}_{est} = {P}_{i}^{est} - {P}_{j}^{est} \\ {Δ}_{Gt} = {P}_{i}^{Gt} - {P}_{j}^{Gt}\end{matrix}$$

The equation to determine the BCE loss 1201 as below:

$$BCE = - \frac{1}{N} {\sum }_{i = 0}^{N} {y}_{i} \cdot log ( {\hat{y}}_{i} ) + ( 1 - {y}_{i} ) \cdot log ( 1 - {\hat{y}}_{i} )$$

Repeatability loss 1202 and 1203 is part of training loss that enforces the repeatability or trackability of the detected features. Repeatability loss 1202 and 1203 is determined by transforming the ground truth features in current frame to subsequent k frames and determine the BCE Loss 1201 between transformed GT features and estimated frame features. Thus, repeatability loss 1202 and 1203 is determined from BCE loss 1201. The equation to determine the total repeatability loss 1204 as below:

$${L}_{Total}^{Repeat} = \frac{1}{k} \times {\sum }_{j = 1}^{k} {wjL}_{j}$$

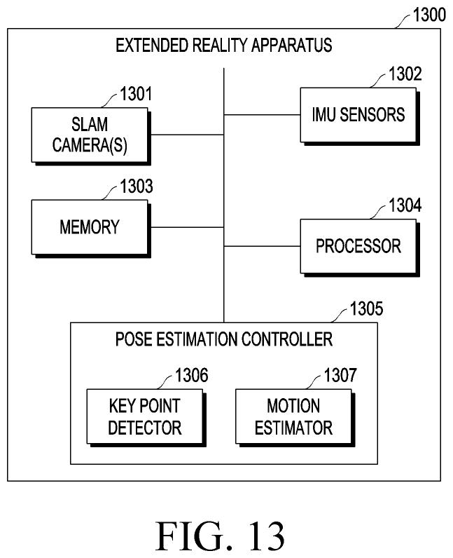

FIG. 13 is a block diagram that illustrates a pose estimation by an XR apparatus according to an embodiment of the disclosure.

Referring to FIG. 13, the memory 1303 is configured to store instructions to be executed by the processor 1304. The memory 1303 can include non-volatile storage elements. Examples of such non-volatile storage elements may include magnetic hard discs, optical discs, floppy discs, flash memories, or forms of electrically programmable read only memories (EPROMs) or electrically erasable and programmable ROMs (EEPROMs). In addition, the memory 1303 may, in some examples, be considered a non-transitory storage medium. The term “non-transitory” may indicate that the storage medium is not embodied in a carrier wave or a propagated signal. However, the term “non-transitory” should not be interpreted that the memory 1303 is non-movable. In some examples, the memory 1303 is configured to store larger amounts of information. In certain examples, a non-transitory storage medium may store data that can, over time, change (e.g., in random access memory (RAM) or cache).

In an embodiment of the disclosure, the processor 1304 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor 1304 may include multiple cores and is configured to execute the instructions stored in the memory 1303.

In an embodiment of the disclosure, the sensor 1302 can include IMU sensor to acquire the motion data of the key points in the keyframes.

In an embodiment of the disclosure, the pose estimation controller 1305, communicatively coupled to the memory 1303 and the processor 1304, configured to receive at least one first frame received from a at least one camera 1301. Further the pose estimation controller 1305 may include a key point detector 1306 and a motion estimator 1307. The pose estimation controller 1305 may determine a first set of key points in the at least one first frame and receive at least one second frame received from the at least one camera 1301. Further, the pose estimation controller 1305 tracks movements of each key point of the first set of key points of the at least one first frame in the at least one second frame and determines the pose of the XR apparatus 1300 based on the tracked movements of each key point of the second set of key points of the at least one second frame.

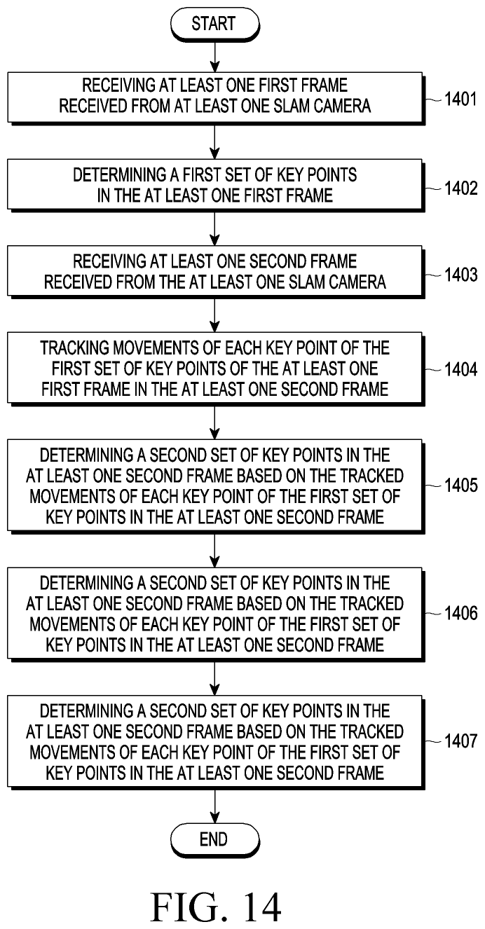

FIG. 14 is a flowchart that illustrates a method for pose estimation by an XR apparatus according to an embodiment of the disclosure.

Referring to FIG. 14, at operation 1401, the method includes receiving, by the XR apparatus 1300, at least one first frame received from one or more camera 1301.

At operation 1402, the method includes determining, by the XR apparatus 1300, a first set of key points in the at least one first frame.

At operation 1403, the method includes receiving, by the XR apparatus 1300, at least one second frame received from the at least one camera 1301.

At operation 1404, the method includes tracking, by the XR apparatus 1300, movements of each key point of the first set of key points of the at least one first frame in the at least one second frame.

At operation 1405, the method includes determining, by the XR apparatus 1300, a second set of key points in the at least one second frame based on the tracked movements of each key point of the first set of key points in the at least one second frame.

At operation 1406, the method includes determining, by the XR apparatus 1300, a second set of key points in the at least one second frame based on the tracked movements of each key point of the first set of key points in the at least one second frame.

At operation 1407, the method includes determining, by the XR apparatus 1300, a second set of key points in the at least one second frame based on the tracked movements of each key point of the first set of key points in the at least one second frame.

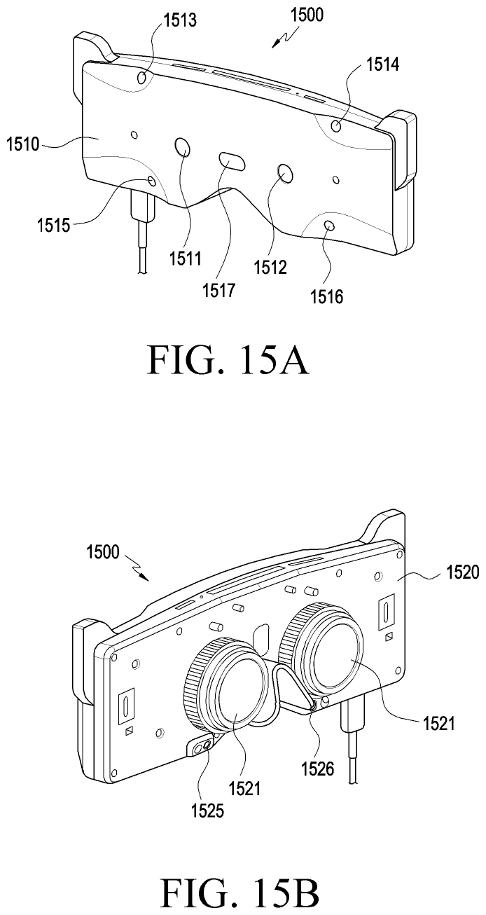

FIGS. 15A and 15B are diagrams illustrating a wearable device 1500 (e.g., an XR apparatus 1300) according to various embodiments of the disclosure.

Referring to FIGS. 15A and 15B, in an embodiment, camera modules 1511, 1512, 1513, 1514, 1515, and 1516 and/or a depth sensor 1517 for obtaining information related to the surrounding environment of the wearable device 1500 may be disposed on a first surface 1515 of the housing. In an embodiment, the camera modules 1511 and 1512 may obtain an image related to the surrounding environment of the wearable device. In an embodiment, the camera modules 1513, 1514, 1515, and 1516 may obtain an image while the wearable device is worn by the user. Images obtained through the camera modules 1513, 1514, 1515, and 1516 may be used for simultaneous localization and mapping (SLAM), 6 degrees of freedom (6DoF), 3 degrees of freedom (3DoF), subject recognition and/or tracking, and may be used as an input of the wearable electronic device by recognizing and/or tracking the user's hand. In an embodiment, the depth sensor 1517 may be configured to transmit a signal and receive a signal reflected from a subject, and may be used to identify the distance to an object, such as time of flight (TOF). According to an embodiment, face recognition camera modules 1525 and 1526 and/or a display 1521 (and/or a lens) may be disposed on the second surface 1520 of the housing. In an embodiment, the face recognition camera modules 1525 and 1526 adjacent to the display may be used for recognizing a user's face or may recognize and/or track both eyes of the user. In an embodiment, the display 1521 (and/or lens) may be disposed on the second surface 1520 of the wearable device 200. In an embodiment, the wearable device may not include the camera modules 1515 and 1516 among a plurality of camera modules 1513, 1514, 1515, and 1516. As described above, the wearable device according to an embodiment may have a form factor for being worn on the user's head. The wearable device may further include a strap for being fixed on the user's body and/or a wearing member. The wearable device may provide a user experience based on augmented reality, virtual reality, and/or mixed reality within a state worn on the user's head.

The proposed solution introduces a pose estimation controller based on learning, which enhances efficiency by exclusively processing the portion of the frame deemed to have the greatest impact on tracking in subsequent frames. This segment of the frame is determined by computing the expected motion of the device using IMU sensor data.

The technical significance of the disclosure lies in its central module, pose estimation controller 1305 (that includes SLAM), which finds application in numerous smart devices. The use of deep learning techniques to obtain precise and consistent keypoints renders system of the related art costly. Therefore, optimization using the proposed pose estimation controller 1305 is necessary to enable its utilization in a technically-ready solution that operates faster than real-time.

Distinguishing oneself from prior art solutions which relies solely on traditional keypoint detectors and results in a subpar accuracy in pose estimation and an excessive use of memory. While certain deep learning based methods offer a resolution to this issue, they are often hindered by a significant increase in running time. The proposed method and XR apparatus 1300, on the other hand, facilitates the utilization of these more resilient methods in a faster-than-real-time capacity, a crucial factor in the commercialization of such modules.

To the proposed solution can be easily detected when the IMU data is used as an additional input to the camera 1301 frame during the detection of keypoints Further, size and parameters of the deep learning based model along with the time taken by the deep learning based model can be used to detect the proposed solution.

The various actions, acts, blocks, steps, or the like in the method may be performed in the order presented, in a different order or simultaneously. Further, in some embodiments of the disclosure, some of the actions, acts, blocks, steps, or the like may be omitted, added, modified, skipped, or the like without departing from the scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments therefore, it will be understood by those skilled in the art that various changes in form and details may be made therein without departing from the spirit and scope of the disclosure as defined by the appended claims and their equivalents.

What is claimed is:

1. A method for estimating a pose of a user of an extended reality (XR) apparatus, the method comprising:
receiving, by the XR apparatus, at least one first frame received from at least one camera;
determining, by the XR apparatus, a first set of key points in the at least one first frame;
receiving, by the XR apparatus, at least one second frame received from the at least one camera;
tracking, by the XR apparatus, movements of each key point of the first set of key points of the at least one first frame in the at least one second frame;
determining, by the XR apparatus, a second set of key points in the at least one second frame based on tracked movements of each key point of the first set of key points in the at least one second frame;
tracking, by the XR apparatus, movements of each key point of the second set of key points of the at least one second frame; and
determining, by the XR apparatus, the pose of the XR apparatus based on the tracked movements of each key point of the second set of key points of the at least one second frame.

2. The method of claim 1, wherein the determining, by the XR apparatus, of the second set of key points in the at least one second frame based on the tracked movements of each key point of the first set of key points in the at least one second frame comprises:
determining, by the XR apparatus, a number of key points from the first set of key points available in the at least one second frame based on the tracked movements of each key point of a set of each key points of the at least one first frame in the at least one second frame;
determining, by the XR apparatus, whether the number of key points meets a key point threshold, wherein the key point threshold indicates an overlap region between the at least one first frame and the at least one second frame; and
determining, by the XR apparatus, the at least one second frame as key frame when the number of key points meets the key point threshold.

3. The method of claim 1, wherein the determining, by the XR apparatus, of the first set of key points in the at least one first frame comprises:
detecting, by the XR apparatus, plurality of key points in at least one frame using a key point detection technique; and
determining, by the XR apparatus, the first set of key points by selecting from the plurality of key points based on at least one of a confidence score of key point, location of key point and relative location of key point.

4. The method of claim 1, wherein the tracking, by the XR apparatus, of movements of each key point of the first set of key points of the at least one first frame in the at least one second frame comprises:
receiving, by the XR apparatus, motion data of each key point of the first set of key points of the at least one first frame in the at least one second frame from at least one Inertial Measurement Unit (IMU) sensor; and
tracking, by the XR apparatus, movements of each key point of the first set of key points of the at least one first frame in the at least one second frame based on the motion data of each key point of the first set of key points of the at least one first frame in the at least one second frame.

5. The method of claim 1, wherein the tracking, by the XR apparatus, of the movements of each key point of the second set of key points of the at least one second frame comprises:
receiving, by the XR apparatus, motion data of each key point of the second set of key points of the at least one second frame from at least one IMU sensor; and
tracking, by the XR apparatus, the movements each key point of the second set of key points of the at least one second frame based on the motion data of each key point of the second set of key points of the at least one second frame.

6. The method of claim 1, wherein the receiving, by the XR apparatus, of at least one second frame received from the at least one camera comprises:
estimating, by the XR apparatus, plurality of second frames of the at least one first frame based on an estimated motion of the at least one camera; and
selecting, by the XR apparatus, at least one second frame from a plurality of second frames having minimum overlapping region with at least first frame, wherein the minimum overlapping region comprises the second set of key points greater than a predefined threshold key points.

7. The method of claim 1, wherein the determining of the second set of key points in the at least one second frame comprises:
dividing, by the XR apparatus, the at least one second frame into a plurality of segments;
determining, by the XR apparatus, coordinates of minimum overlap region between at least one first frame and at least one second frame by remapping a coordinate of the plurality of segments with image coordinates of at least one second frame; and
determining, by the XR apparatus, the second set of key points on the minimum overlapping region.

8. The method of claim 7, wherein the determining of the minimum overlap region between the at least one first frame and the at least second frame comprises:
determining, by the XR apparatus, a location of the at least one second frame in estimated motion direction of the camera based on number of frames generated per second;
rotating, by the XR apparatus, at least one second frame in a frame location; and
determining, by the XR apparatus, minimum overlapping region between the rotated at least one second frame and the at least one first frame.

9. An extended reality (XR) apparatus for estimating a pose of a user comprises:
memory storing one or more computer programs;
one or more processors; and
a pose estimation controller, communicatively coupled to the memory and the one or more processors,
wherein the one or more computer programs include computer-executable instructions that, when executed by the one or more processors individually or collectively, cause the XR apparatus to:
receive at least one first frame received from a at least one camera, determine a first set of key points in the at least one first frame,
receive at least one second frame received from the at least one camera, track movements of each key point of the first set of key points of the at least one first frame in the at least one second frame, and
determine the pose of the XR apparatus based on the tracked movements of each key point of a second set of key points of the at least one second frame.

10. The XR apparatus of claim 9, wherein the one or more computer programs further include computer-executable instructions that, when executed by the one or more processors individually or collectively, cause the XR apparatus to:
determine the second set of key points in the at least one second frame based on the tracked movements of each key point of the first set of key points in the at least one second frame,
determine a number of key points from the first set of key points available in the at least one second frame based on the tracked movements of each key point of a set of each key points of the at least one first frame in the at least one second frame,
determine whether the number of key points meets a key point threshold, wherein the key point threshold indicates an overlap region between the at least one first frame and the at least one second frame, and
determine, by the XR apparatus, the at least one second frame as key frame when the number of key points meets the key point threshold.

11. The XR apparatus of claim 9, wherein the one or more computer programs further include computer-executable instructions that, when executed by the one or more processors individually or collectively, cause the XR apparatus to:
detect plurality of key points in at least one frame using a key point detection technique, and
determine, by the XR apparatus, the first set of key points by selecting from the plurality of key points based on at least one of a confidence score of key point, location of key point and relative location of key point.

12. The XR apparatus of claim 9, wherein the one or more computer programs further include computer-executable instructions that, when executed by the one or more processors individually or collectively, cause the XR apparatus to:
receive motion data of each key point of the first set of key points of the at least one first frame in the at least one second frame from at least one inertial measurement unit (IMU) sensor, and
track movements of each key point of the first set of key points of the at least one first frame in the at least one second frame based on the motion data of each key point of the first set of key points of the at least one first frame in the at least one second frame.

13. The XR apparatus of claim 9, wherein the one or more computer programs further include computer-executable instructions that, when executed by the one or more processors individually or collectively, cause the XR apparatus to:
receive motion data of each key point of the second set of key points of the at least one second frame from at least one IMU sensor, and
track the movements each key point of the second set of key points of the at least one second frame based on the motion data of each key point of the second set of key points of the at least one second frame.

14. The XR apparatus of claim 9, wherein the one or more computer programs further include computer-executable instructions that, when executed by the one or more processors individually or collectively, cause the XR apparatus to:
estimate plurality of second frames of the at least one first frame based on an estimated motion of the at least one camera, and
select at least one second frame from a plurality of second frames having minimum overlapping region with at least first frame, wherein the minimum overlapping region comprises the second set of key points greater than a predefined threshold key points.

15. The XR apparatus of claim 9, wherein the one or more computer programs further include computer-executable instructions that, when executed by the one or more processors individually or collectively, cause the XR apparatus to:
divide the at least one second frame into a plurality of segments,
determine coordinates of minimum overlap region between at least one first frame and at least one second frame by remapping a coordinate of the plurality of segments with image coordinates of at least one second frame, and
determine the second set of key points on the minimum overlapping region.

16. The XR apparatus of claim 14, wherein the one or more computer programs further include computer-executable instructions that, when executed by the one or more processors individually or collectively, cause the XR apparatus to:
determine a location of the at least one second frame in estimated motion direction of the camera based on number of frames generated per second,
transform view of the at least one second frame in a frame location by rotating and translating in the estimated motion of the camera, and
determine minimum overlapping region between the transformed at least one second frame and the at least one first frame.

17. One or more non-transitory computer-readable storage media storing computer-executable instructions that, when executed by one or more processors individually or collectively, cause an extended reality (XR) apparatus to perform operations of estimating a pose of a user, the operations comprising:
receiving, by the XR apparatus, at least one first frame received from a at least one camera;
determining, by the XR apparatus, a first set of key points in the at least one first frame;
receiving, by the XR apparatus, at least one second frame received from the at least one camera;
tracking, by the XR apparatus, movements of each key point of the first set of key points of the at least one first frame in the at least one second frame;
determining, by the XR apparatus, a second set of key points in the at least one second frame based on tracked movements of each key point of the first set of key points in the at least one second frame;
tracking, by the XR apparatus, movements of each key point of the second set of key points of the at least one second frame; and
determining, by the XR apparatus, the pose of the XR apparatus based on the tracked movements of each key point of the second set of key points of the at least one second frame.

18. The one or more non-transitory computer-readable storage media of claim 17, the operations further comprising:
determining, by the XR apparatus, a number of key points from the first set of key points available in the at least one second frame based on the tracked movements of each key point of a set of each key points of the at least one first frame in the at least one second frame;
determining, by the XR apparatus, whether the number of key points meets a key point threshold, wherein the key point threshold indicates an overlap region between the at least one first frame and the at least one second frame; and
determining, by the XR apparatus, the at least one second frame as key frame when the number of key points meets the key point threshold.

19. The one or more non-transitory computer-readable storage media of claim 17, the operations further comprising:
detecting, by the XR apparatus, plurality of key points in at least one frame using a key point detection technique; and
determining, by the XR apparatus, the first set of key points by selecting from the plurality of key points based on at least one of a confidence score of key point, location of key point and relative location of key point.

20. The one or more non-transitory computer-readable storage media of claim 17, the operations further comprising:
receiving, by the XR apparatus, motion data of each key point of the first set of key points of the at least one first frame in the at least one second frame from at least one Inertial Measurement Unit (IMU) sensor; and
tracking, by the XR apparatus, movements of each key point of the first set of key points of the at least one first frame in the at least one second frame based on the motion data of each key point of the first set of key points of the at least one first frame in the at least one second frame.
